(19) United States
(12) Patent Application Publication
(10) Pub. No.: US 2011/0188070 A1
(43) Pub. Date: Aug. 4, 2011

(54) DETECTION AND REPLACEMENT OF CONSUMABLE COMPONENTS OF COMPUTER PERIPHERALS

(76) Inventors: Serhat Pala, San Diego, CA (US); Hikmet Can Celik, San Diego, CA (US); Deniz Turkmen, San Diego, CA (US)

(21) Appl. No.: 12/696,913

(22) Filed: Jan. 29, 2010

(51) Int. Cl. G06F 15/00

(52) U.S. Cl. 358/1.15

(57) ABSTRACT

The present invention provides a technique for detecting and replacing consumable components, e.g., printer cartridges, of computer peripherals, e.g., printers. In an exemplary embodiment of the invention, a consumer loads a web page of a printer cartridge supplier. The web page includes a link to a server-based software application for identifying suitable replacement printer cartridges for the consumer. Upon download and activation by the consumer, the software scans the operating system of the consumer's local computer to determine the number and types of printer drivers installed on that computer. Generally, each printer driver is associated with a particular make and model of a peripheral printer connected to the consumer's computer. By determining the types of printer drivers existing on the consumer's computer, the software is able to identify the specific printers belonging to the consumer, and in turn facilitates the recommendation of suitable replacement cartridges and accessories for those printers. A list of those replacement cartridges and accessories is displayed to the consumer, from which the consumer may select and purchase.

### BACKGROUND OF THE INVENTION

1. Field of Invention

The present invention relates to computer peripherals, e.g., printers, and more specifically, to a technique for detecting a make and model of a computer peripheral and facilitating the purchase of suitable replacement consumable components, e.g., printer cartridges, of the detected computer peripheral.

2. Description of Related Art

A peripheral is a device attached to a host computer, but not part of it whose primary functionality is dependent upon the host. Example peripherals include, but are not limited to printers, scanners, tape drives, microphones, speakers, webcams, and cameras. Whether something is a peripheral or part of a computer is not always clearly demarcated. For example, a video capture card inside a computer case is not part of the core computer, but is contained in the computer's housing. However, whether something can be considered a peripheral or not is a trivial matter of nomenclature.

A printer is a computer peripheral that produces a hard copy (permanent readable text and/or graphics) of documents stored in electronic form, usually on physical print media such as paper or transparencies. Printers are routinely classified by the underlying print technology they employ; numerous such technologies have been developed over the years. For example, the following printing technologies are routinely found in modern printers: liquid inkjet printers and toner-based printers.

Inkjet printers operate by propelling variably-sized droplets of liquid or molten material, e.g., ink, onto almost any sized page. They are the most common type of computer printer for the general consumer. An ink cartridge or inkjet cartridge is a replaceable and consumable component of an inkjet printer that contains the ink (and sometimes the printhead itself) that is spread on paper during printing. Each ink cartridge contains one or more partitioned ink reservoirs. Certain manufacturers also add electronic contacts and a chip that communicates with the printer. Most consumer inkjet printers, such as those made by Canon, HP, and Lexmark use a thermal inkjet—inside each partition of the ink reservoir is a heating element with a tiny metal plate or resistor. In response to a signal given by the printer, a low level electrical current flows through the metal or resistor making it warm, and the ink immediately surrounding the heated plate is vaporized into a tiny air bubble inside the nozzle. As a consequence, the total volume of the ink exceeds that of the nozzle. An ink droplet is forced out of the cartridge nozzle onto the paper. This process takes a matter of milliseconds.

Toner-based printers work using the Xerographic principle that is used in most photocopiers: by adhering toner to a light-sensitive print drum, then using static electricity to transfer the toner to the printing medium to which it is fused with heat and pressure. The most common type of toner-based printer is the laser printer, which uses precision lasers to cause toner adherence. Laser printers are known for high quality prints, good print speed, and a low cost-per-copy when printing in black and white. They are the most common printer for many general-purpose office applications, but are much less common as consumer printers due to their relatively high initial cost. Laser printers are available in both color and monochrome varieties. Another toner based printer is the light emitting diode (LED) printer which uses an array of LEDs instead of a laser to cause toner adhesion to the print drum. A toner cartridge, also called laser toner, is the consumable component of a laser printer. Toner cartridges contain toner powder, a fine, dry mixture of plastic particles, carbon, and black or other coloring agents that make the actual image on the paper.

Because inkjet, toner, and other types of printer cartridges (collectively referred to as “printer cartridges”) contain a finite volume of ink or toner, and hence have a limited life span, those cartridges will eventually have to be replaced to continue printing. In fact, many printer manufacturers sell a printer at cost knowing that they can recoup the foregone profit, if not more, on the sale of the printer in the sale of replacement printer cartridges. Over the typical life of a printer, the user must replace the printer cartridges numerous times. In color printers, the user has to replace each of several printer cartridges corresponding to the respective color cartridges implemented in the printer, e.g., black, magenta, cyan, and yellow.

Conventional printers may also employ dot or impact matrix technology. In a dot matrix printer, a printhead strikes an ink-soaked cloth ribbon against printer paper. Each dot is produced by a tiny metal rod, which is driven forward by the power of a tiny electromagnet or solenoid and guided by a small guide plate. Unlike other printers, dot matrix printers can print on multi-part stationery or make carbon-copies and are useful for data logging on continuous paper. Dot matrix printers can be highly durable, but often wear out when the circles on the guide plate become constricted due to grit build-up resulting in unclear printing. Dot matrix printers are also prone to bent pins (and therefore a destroyed printhead) caused by printing a character half-on and half-off the label. The printhead and cloth ribbon are consumable components that will likely need to be replaced over the life of the printer.

Three-dimensional (3D) technology is being implemented in conventional printers. 3D printing is a form of additive manufacturing technology where a product prototype is created by successive layers of material. Advanced 3D printing technologies are used in the jewelry, footwear, industrial design, architecture, automotive, aerospace, dental and medical industries. In a typical 3D printing system, layers of a fine powder are bonded by “printing” an adhesive from the inkjet printhead in the shape of each cross-section as determined by a computer-aided design (CAD) file. The powder can be plaster, corn starch, or resins. In other 3D printing systems, a photopolymer liquid is fed through an inkjet-type printhead with an ultraviolet (UV) flood lamp to cure and form each layer of the prototype. The printhead, powder, photopolymer liquid, and adhesives are consumable components that will likely need to be replaced over the life of the printer.

In addition, certain printers use thermal technology. A direct thermal printer selectively heats coated thermochromic paper when the paper passes over a thermal printhead. As the coating is heated it turns black (and in some printers additional colors) creating an image. Different temperatures yield different colors. Thermal printers typically comprise the following components: a thermal printhead that generates heat and prints on paper, a platen, which is a rubber roller that feeds paper, a spring which applies pressure to the thermal head causing it to contact the thermo-sensitive paper and controller boards for controlling the mechanism. The thermal printhead, platen, and spring are consumable components that will likely need to be replaced over the life of the printer.

The prevalent use of computer peripherals such as printers in modern society creates a need to facilitate ordering of replacement printer cartridges and other consumable supplies or accessories including, but not limited to drums, specialty paper, printheads, resins, springs, maintenance units, and cables. The ordering of peripheral components and consumables can be time-consuming and prone to errors in selection given the wide range of commercially available peripheral devices.

Several conventional techniques for facilitating replacement of printer cartridges have been implemented in the printer market. For example, U.S. Pat. No. 7,216,951, the disclosure of which is herein incorporated by reference in its entirety, discloses a software application activated by the user that resides on the user's computer for detecting when ink in a printer cartridge of a peripheral printer is low, e.g., below a predetermined threshold. Upon such detection, the software automatically orders a replacement cartridge from a supplier or alternatively, prompts the user to connect to a website of the printer supplier to order a replacement cartridge. Similar techniques are disclosed in U.S. Patent Publication No. 2002/0062287, U.S. Patent Publication No. 2007/0188530, U.S. Pat. No. 6,113,208, U.S. Patent Publication No. 2008/0071626, U.S. Patent Publication No. 2005/0283666, U.S. Patent Publication No. 2005/0047803, U.S. Patent Publication No. 2008/0118256, U.S. Pat. No. 6,798,997, and U.S. Patent Publication No. 2003/0074428, the disclosures of which are herein incorporated by reference in their entirety. A major drawback of these systems is that the local software directs the consumer to purchase a replacement cartridge from a pre-specified printer cartridge supplier, which is usually the original equipment manufacturer (OEM). The consumer is not given the option to purchase replacement printer cartridges from third party suppliers, e.g., suppliers of cheaper compatible or remanufactured printer cartridges. The consumer is also not given the option to purchase other compatible supplies and accessories that might go with the printer such as, but not limited to drums, specialty paper, printheads, resins, springs, maintenance units and cables. Moreover, low ink detection software as disclosed in the prior art must be installed and activated in advance by the consumer.

### SUMMARY OF THE INVENTION

The present invention overcomes these and other deficiencies of the prior art by providing a method and system for detecting the type of computer peripheral, e.g., printer manufacturer and specific model, and identifying suitable replacement components, e.g., printer cartridges, or other accessories for use in the computer peripheral from a remote server over a computer network such as the Internet. The remote server can be a web server facilitated by a third party supplier of peripheral components. A consumer connects to the server via the Internet and authorizes software such as a Java applet to be downloaded from the server. The software scans the operating system of the computer in order to identify the drivers that have been installed on that computer. By identifying the drivers, the software is able to determine the make and model of the corresponding peripherals, and in turn one or more suitable replacement components. The remote server is able to then facilitate the purchase and delivery of those replacement components to the consumer.

In an embodiment of the invention, a device comprises: a driver detection program for detecting a peripheral driver installed on a computer coupled to the computer network; and a user interface for displaying information pertaining to a peripheral associated with the detected peripheral driver. The information is selected from the group consisting of: peripheral make, peripheral model number, peripheral component make, peripheral component model number, accessory make, accessory model number, and any combination thereof. The user interface permits selection of a component or accessory that is suitable for use with the peripheral and facilitates purchase of the selected component or accessory. The peripheral may comprise a printer and the information comprises identification of a printer cartridge suitable for the printer. The driver detection program comprises a Java applet. The device further comprises a database, wherein the database cross-references the detected peripheral driver to the information pertaining to the peripheral.

In another embodiment of the invention, a method of identifying a computer peripheral component, the method being implemented on a computer and comprises the steps of: scanning an operating system of a computer to identify one or more peripheral drivers, matching the identified peripheral driver to a corresponding peripheral, and identifying a computer peripheral component or accessory that is suitable for use with the corresponding peripheral. The step of scanning is performed by a software program. The method further comprises the step of downloading the software program to the computer. The step of matching comprises the step of comparing the identified peripheral driver to a list of peripheral drivers, wherein each listed peripheral driver is associated with a computer peripheral. The list of peripheral drivers is stored in a database. The peripheral driver may be a printer driver and the corresponding peripheral comprises a printer. The method may further comprise the steps of: transmitting information about the identified computer peripheral component or accessory to the computer, and facilitating the purchase of the identified computer peripheral component or accessory.

In yet another embodiment of the invention, a method of identifying a printer cartridge, the method being implemented on a computer and comprises the steps of: scanning an operating system of a computer to identify one or more print drivers, matching the identified print driver to a corresponding printer, and identifying a printer cartridge or printer accessory that is suitable for use with the corresponding printer. The step of scanning is performed by a software program. The method further comprises the step of downloading the software program to the computer. The step of matching comprises the step of comparing the identified printer driver to a list of printer drivers, wherein each of the listed printer drivers is associated with a printer. The list of printer drivers is stored in a database. The method may further comprise the steps of transmitting information about the identified printer cartridge or printer accessory to the computer, and facilitating the purchase of the identified printer cartridge or printer accessory.

An advantage of the invention is that replacement of printer cartridges and other components is facilitated through a centralized and remote server, which automatically identifies suitable replacement components for a user's printer. The centralized server then facilitates the purchase and delivery of those components to the consumer without requiring the user to search or find their replacement from a list that includes incompatible components. If the peripheral is a printer, another advantage of the invention is that the consumer need not have to have low-ink level detection software built into his or her printer system. Another advantage is the invention provides a convenient and user friendly web-based interface, which lists the most appropriate replacement components for a user's peripheral after the driver detection scan is complete. As a result, ordering of replacement components is simplified and user error during ordering is minimized In addition, the invention can be implemented as a Java applet and is therefore interoperable on multiple computer platforms such as, but not limited to Windows, Mac and Linux. The invention can provide relevant manual and troubleshooting information to the user as well. All of these advantages provide a website vendor with a tool for speeding up and facilitating the replacement ordering process will result in increased orders over time.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a printer cartridge detection and ordering system according to an embodiment of the invention; and

FIG. 2 illustrates a printer cartridge detection and ordering process according to an embodiment of the invention.

### DETAILED DESCRIPTION OF EMBODIMENTS

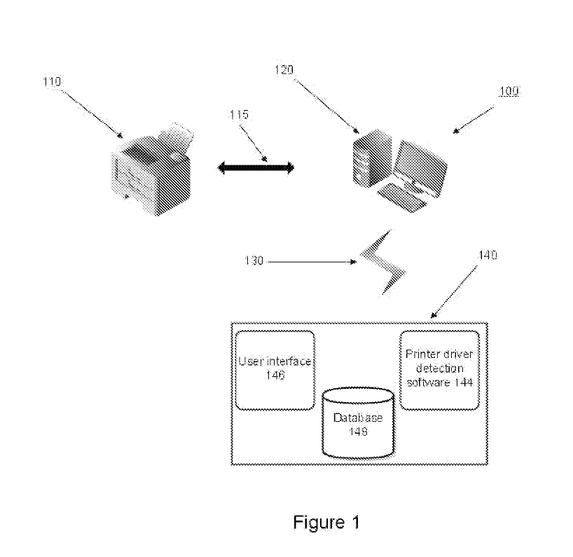

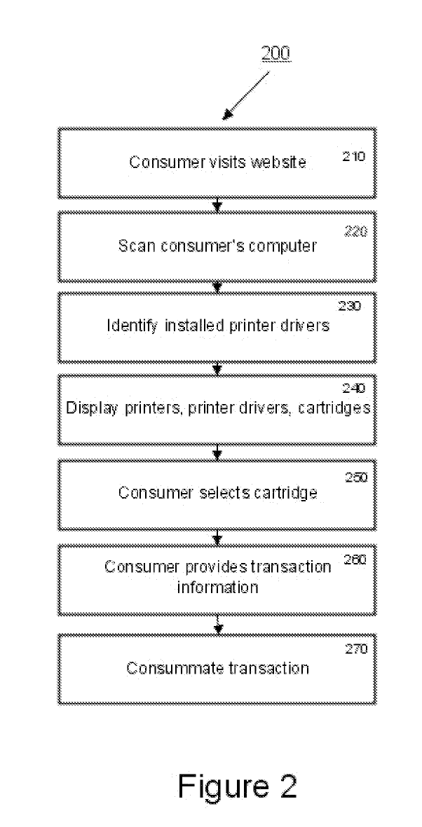

Further features and advantages of the invention, as well as the structure and operation of various embodiments of the invention, are described in detail below with reference to the accompanying FIGS. 1-2, wherein like reference numerals refer to like elements. Although the present invention is described in the context of printer cartridges for printers, one of ordinary skill in the art readily appreciates that the present invention is applicable to any type of computer peripheral—not just printers—and peripheral components, as well as other types of accessories where the existence and identification of such can be detected by identifying a respective software driver residing on the host computer.

In an exemplary embodiment of the invention, an automated printer cartridge re-ordering method and system is provided. A consumer loads a web page of a printer cartridge supplier. The web page includes a link to a server-based software application for identifying suitable replacement printer cartridges for the consumer. Upon download and activation by the consumer, the software scans the consumer's operating system of the local computer to determine the number and types of printer drivers installed on that computer. Generally, each printer driver is associated with a particular make and model of a peripheral printer. By determining the types of printer drivers existing on the consumer's computer, the specific make and model of one or more printers belonging to the consumer can be identified. In turn, the vendor's website is able to recommend suitable replacement printer cartridges for those printers. A list of those replacement cartridges is displayed to the consumer, from which the consumer may select and purchase one or more of those cartridges.

FIG. 1 illustrates a printer cartridge detection and ordering system 100 according to an embodiment of the invention. Particularly, the printer cartridge detection and ordering system 100 comprises a printer 110, a computer 120 coupled to the printer 110, a two-way communications link 130, and a remote server 140. The printer 110 may be an inkjet printer, toner-based printer, or some other type of printer that implements one or more replaceable printer cartridges (not shown) or accessories. The printer 110 is coupled to the computer 120 through a suitable wired or wireless communications link 115. Examples of a wired communication link, i.e., printer cable, include a universal serial bus (USB) cable, a recommended standard 232 (RS-232) cable, and an Institute of Electrical and Electronics Engineers (IEEE) 1394 cable. Examples of a wireless communications link include IEEE 802.11 standard (commonly referred to as Wi-Fi) communications and Bluetooth communications. However, one of ordinary skill in the art appreciates that these and other types of communications links, and any combination thereof, may be implemented as the communications link 115. The printer 110 does not need to be powered on or even present for the invention to work. One of ordinary skill in the art appreciates that the printer 110 is exemplary only and may represent any type of computer peripheral.

The computer 120 may be any type of computing device including a network of computers that includes one or more printer drivers (not shown) specific to the printer 110 make and model. Typically, a computer includes a processor, a display or monitor, and a data input means such as a keyboard and/or mouse, and an operating system. A driver is a software program that facilitates communication between the computer and a peripheral device. A printer driver is a piece of software that converts the data to be printed to a form specific to the printer 110. The purpose of the printer driver is to allow software applications on the computer 120 to print without being aware of the technical details of each printer model. Often, each printer driver is associated with a specific printer model. However, unified printer drivers exist for different, but similar printer models, which typically use the same cartridges or accessories. Often, the printer driver comes on a compact disc (CD) with the purchase of the printer 110 and is installed on the computer 120 via the CD when the printer 110 is first connected to the computer 120. Alternatively, a printer driver may be downloaded to the computer 120 via the Internet. A printer driver indicates the make and model of the printer 110, as well as the make and model of the printer cartridges suitable for that printer 110. Although only one printer 110 is shown, multiple printers 110 may be coupled to the computer 120. In that case, multiple printer drivers will exist, each one corresponding to a different printer 110 make and model.

The computer 120 is connected to the Internet, and hence the remote server 140, via the two-way communications link 130, which may comprise one or more wired and/or wireless communications links coupled to a network node, which is in turn coupled to the Internet by a service provider. For example, the communications link 130 may connect the computer 120 to the Internet through a Wi-Fi channel provided by an access point (not shown), which is in turn coupled to a digital subscriber line (DSL) provided by an Internet service provider. Nonetheless, other types of communications links may be implemented as link 130, the identification and implementation of which is apparent to one of ordinary skill in the art. The communications link 130 facilitates communications between the computer 120 and the remote server 140.

In an embodiment of the invention, the remote server 140 comprises a web server, which includes printer driver detection software 144, a user interface 146, and a database 148. The printer driver detection software 144 comprises a set of executable instructions for detecting the printer drivers installed on the computer 120, and hence the printers 110 that are currently or previously coupled to the computer 120. After the consumer, i.e., user, of the printer 110 and computer 120 grants permission, the printer driver detection software 144 is downloaded to the computer 120 and executed. The software 144 scans the computer 120 to identify those printer drivers installed to the operating system (OS) of the computer 120. In an embodiment of the invention, the driver detection software 144 is written in Java as part of an applet, which is OS independent. As a result, the driver detection software 144 is able to run on any operation system such as, but not limited to Windows, Mac, and Linux.

Once the detection software 144 identifies the printer drivers installed on the computer 120, the results of the scan are displayed to the consumer through the user interface 146. The results include a list of printers 110 as determined by the detected drivers. After the user selects their listed printer 110, the information including the printer 110 and drivers is sent to the database 148 where matching is performed by cross-referencing the identified printer drivers to a list of printer drivers and to one or more suitable replacement printer cartridges suitable for the printer 110. The results of the cross-referencing are then presented to the user via the user interface 146 where the user selects the suitable replacement cartridge for order.

The results of the printer driver detection software 144 are displayed to a consumer, i.e., user of the printer 110 and computer 120, through the user interface 146. In an embodiment of the invention, the user interface 146 is a web-based interface. For example, the user interface 146 may create hypertext markup language (HTML) pages, i.e., web pages, the implementation of which is apparent to one of ordinary skill in the art, that may displayed on the computer 120 via an appropriate web browser. In at least one embodiment of the invention, the user interface 146 displays the make and model of each printer 110 identified through the printer driver detection software 144, as well the make and model of suitable printer cartridges for each printer 110. The user interface 146 may further facilitate the display of pricing information for those printer cartridges and a link for ordering such. For example, if the printer driver detection software 144 identified a printer driver associated with a HP black and white laser printer model number 1022, the user interface 146 would facilitate the display of the printer model—HP 1022; the model number of the toner cartridge needed for that printer, i.e., HP Q2612A, and appropriate information allowing the user to order that printer cartridge. If more than one printer cartridges are suitable, then the user interface 146 can facilitate the display of all of those suitable printer cartridges, from which the user may select one or more for purchase.

Purchase of replacement printer cartridges may be carried out in any conventional manner, the identification and implementation of which is apparent to one of ordinary skill in the art. For example, a consumer may set up an account including all of the required transaction information, e.g., name, e-mail address, shipping address, credit card information, invoicing information, etc. via the user interface 146 permitting one-click ordering after the consumer selects the most appropriate replacement cartridge. Once payment is tendered, the replacement cartridge will be shipped to the appropriate shipping address. A consumer may also opt for reminders of future orders.

FIG. 2 illustrates a printer cartridge detection and ordering process 200 according to an embodiment of the invention. The process is initiated by a consumer visiting (step 210) an appropriate website such as printcountry.com. After the consumer grants permission, a Java applet is download and executed. The Java applet scans (step 220) the operating system on the consumer's computer to identify (step 230) the printer drivers installed on that computer as described above. After the consumer selects their printer from a displayed list (step 240) of potential printers detected, the website then displays a second list of suitable replacement printer cartridges corresponding to the selected printer. The consumer is then able to select (step 250) one or more replacement printer cartridges for purchase. The consumer then provides (step 260) the requisite payment information and a shipping address. Once payment is authorized, the purchase transaction is consummated (step 270) and the selected printer cartridges are shipped to the consumer.

The present invention facilitates the ordering of replacement printer cartridge without requiring additional printer owner equipment (e.g., software, ink detection sensors). The remote detection software employs a portable user interface for vendor websites that provides website visitors with an automated, convenient, and user friendly process by which the user can select a replacement cartridge from a list of suitable replacement cartridges. This software may be implemented as part of a larger e-commerce website. It may also be used by websites that serve as advertising middlemen, which link consumers to suitable vendors after the cartridge or accessory is determined

Although the invention has been described as a web-based system, one of ordinary skill in the art recognizes that other types of communication networks may be implemented. For example, the remote server may be implemented on a private local area network such as that belonging to a large corporation or university. The remote server is able to detect the make and model of a network user's printer and thus, supply the user with a suitable replacement printer cartridge from a central purchasing and supply department belonging to the corporation or university.

Again, the printer driver detection software 144 is exemplary only. Computer peripherals other than printers may be detected by identifying the respective drivers for those peripherals. For example, the computer 120 may be coupled to a tape or zip drive (not shown) that is associated with a driver. Upon a scan of the local operating system, the driver detection software 144 is capable of detecting the tape or zip drive driver in order to identify the make and model of the tape or zip drive. By knowing the make and model of the tape or zip drive, the remote server 140 is able to identify suitable tapes or removable zip storage disks that function properly with the tape or zip drive for purchase by a consumer.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A device comprising:
a driver detection program for detecting a peripheral driver installed on a computer coupled to the computer network; and
a user interface for displaying information pertaining to a peripheral associated with the detected peripheral driver.

2. The device of claim 1, wherein the information is selected from the group consisting of: peripheral make, peripheral model number, peripheral component make, peripheral component model number, accessory make, accessory model number, and any combination thereof.

3. The device of claim 1, wherein the user interface permits selection of a component or accessory that is suitable for use with the peripheral.

4. The device of claim 3, wherein the user interface facilitates purchase of the selected component or accessory.

5. The device of claim 1, wherein the peripheral comprises a printer and the information comprises identification of a printer cartridge suitable for the printer.

6. The device of claim 1, wherein the driver detection program comprises a Java applet.

7. The device of claim 1, further comprising a database, wherein the database cross-references the detected peripheral driver to the information pertaining to the peripheral.

8. A method of identifying a computer peripheral component, the method being implemented on a computer and comprising the steps of:
scanning an operating system of a computer to identify one or more peripheral drivers,
matching the identified peripheral driver to a corresponding peripheral, and
identifying a computer peripheral component or accessory that is suitable for use with the corresponding peripheral.

9. The method of claim 8, wherein is the step of scanning is performed by a software program.

10. The method of claim 9, further comprising the step of downloading the software program to the computer.

11. The method of claim 8, wherein the step of matching comprises the step of:
comparing the identified peripheral driver to a list of peripheral drivers, wherein each listed peripheral driver is associated with a computer peripheral.

12. The method of claim 11, wherein the list of peripheral drivers is stored in a database.

13. The method of claim 8, wherein the peripheral driver is a printer driver and the corresponding peripheral comprises a printer.

14. The method of claim 8, further comprising the steps of:
transmitting information about the identified computer peripheral component or accessory to the computer, and
facilitating the purchase of the identified computer peripheral component or accessory.

15. A method of identifying a printer cartridge, the method being implemented on a computer and comprising the steps of:
scanning an operating system of a computer to identify one or more print drivers,
matching the identified print driver to a corresponding printer, and
identifying a printer cartridge or printer accessory that is suitable for use with the corresponding printer.

16. The method of claim 15, wherein is the step of scanning is performed by a software program.

17. The method of claim 16, further comprising the step of downloading the software program to the computer.

18. The method of claim 15, wherein the step of matching comprises the step of:
comparing the identified printer driver to a list of printer drivers, wherein each listed printer driver is associated with a printer.

19. The method of claim 18, wherein the list of printer drivers is stored in a database.

20. The method of claim 15, further comprising the steps of:
transmitting information about the identified printer cartridge or printer accessory to the computer, and
facilitating the purchase of the identified printer cartridge or printer accessory.
